(19) United States
(12) Patent Application Publication
(10) Pub. No.: US 2004/0247762 A1
(43) Pub. Date: Dec. 9, 2004

(54) [Automatic Roasting Apparatus]

(76) Inventors: Zhaoxia Xu, Ypsilanti, MI (US); Zheng Peng, Ypsilanti, MI (US)

Correspondence Address: ZHAOXIA XU, 4694 SYCAMORE DR., YPSILANTI, MI, 48197, US

(21) Appl. No.: 10/250,170

(22) Filed: Jun. 9, 2003

(51) Int. Cl. A23C 3/00

(52) U.S. Cl. 426/523

(57) ABSTRACT

An automatic roasting apparatus (100). This roasting apparatus includes a container (102) having an open top, a lid (104) for covering on top of container (102), heating means installed inside container (102) for heating foods, a rotating device (105) removably installed inside container (102) for holding foods, a motor (106) operationally connected to rotating device (105) through a transmission assembly (110) for driving rotating device (105), and a forced venting system, which includes a venting device (200) and a blowing device (202) for forcing fresh air into roasting apparatus (100), such that the evaporation and removal of food moisture is facilitated and the oil vapor content and odors in the cooking fumes are removed before the air is exhausted into the room. Container (102) is divided into an upper portion (102a) and a lower portion (102b) for facilitating cleaning after use. A compact roasting chamber design favors maximum energy efficiency. After the food is satisfactorily processed, blowing device (202) forces fresh air into roasting apparatus (100) for cooling the food down to a predetermined temperature for safety of food handling, for preserving important roasted food characteristics, and for purging the residual cooking fumes. A control module (189) controls the whole roasting process in a programmed automatic manner. This invention has various utilities, such as roasting, frying, baking, fruit/vegetable drying, etc.

### BACKGROUND OF INVENTION

This invention generally relates to cooking/food processing apparatuses. More specifically, this invention relates to automatic roasting, frying, baking, and fruit/vegetable drying apparatuses.

Roasting is a widely used method for preparing foods. Roasted foods, similar to fried foods, are tasteful due to their specific taste and texture. Two of the most important characteristics of roasted foods are: outside, golden and crispy; and inside, juicy and tender. Roasted foods are especially preferred to fried foods in many cases, such as in preparing semi-cooked frozen foods, like French fries, chicken nuggets, fried shrimps, etc., due to the relatively low fat feature. There is an ever-increasing concern over the amount of oil or fat in one's diet for general public. In particular, a low fat diet is more desirable in light of related health concerns.

However, there are some issues associated with preparing roasted foods at home.

Unlike in frying, in which heat is transferred to the food through heated oil as a heating media, in roasting the food is heated through radiation and heated air as a heating media. When the roasting chamber is heated air is the primary heating media. In this case, heating efficiency is significantly lower. It takes much longer time and much more energy to process the food. On the other hand, if the roasting chamber is radiation is becoming the dominant heating mechanism. In this case, the heating is hardly uniform, thereby, locally scorching the food.

Each home is equipped with a stove having a large roasting chamber. Since the roasting chamber is too large for daily meals, it is highly inefficient in operation, thereby hindering its application.

There are many smaller roasting oven products on the market. They are better suited for daily meals or food re-heating. These roasting ovens have a roasting chamber and are generally equipped with an oil tray for collecting the dripping down grease. Since the roasting chamber is small, the splattering of oil and food particles makes the interior chamber greasy and hard to clean. In addition, heating uniformity is becoming a big issue.

Over years, various roasting ovens have been developed to address some of these problems and many patents have been granted.

U.S. Pat. No. 6,076,453, issued to Hsu, on Jun. 20, 2000, teaches a multipurpose roaster comprising a frame, fixtures and a skewer. Concentration is on rotary frame designs for various applications.

U.S. Pat. No. 6,125,737, issued to Chang, on Oct. 3, 2000, describes a baking pot comprising a casing, an inner pot, a heating tube, a fan for circulating the air inside the inner pot.

U.S. Pat. No. 6,178,879, issued to Park, on Jan. 30, 2001, describes a portable roaster, which can make fire with charcoal as well as gas.

U.S. Pat. No. 6,230,702, issued to Lee, on May 15, 2001, teaches a baking oven having a movable up-and-down cover. The movable cover is provided to close on a housing to adjust an inner hollow chamber so as to save baking time and energy.

U.S. Pat. No. 6,363,841, issued to Chen, on Apr. 2, 2002, teaches a roaster oven includes a rotatable frame, an oil tray, and an oil-guiding member for guiding the splashing oil down to the oil tray.

A common shortcoming of these prior art products is that they generally allow the cooking fume to be discharged out of the roasting chamber into the kitchen. The cooking fume is posing a health threat to the people who are preparing the food because they involuntarily inhale the cooking fume during the cooking process. On the other hand, the cooking fume generated in the cooking process might easily reach much farther in the kitchen or even other rooms and deposit on the furniture, paintings, electrical appliances, etc., thereby causing long-term hazards to home environment. In addition, the cooking fume also deposits on the inside and outside of the roasting oven, especially in the vicinity of open slots, forming sticky grease layer, which is very tough to clean.

Another common shortcoming of these prior art products is associated with their low energy efficiency. Since the cooking fume is discharged out of the roasting chamber freely through some open slots, heated air goes out as well, thereby, causing heating energy loss. A properly designed roasting apparatus should have a well-sealed roasting chamber for avoiding energy loss. On the other hand, the interior space should be minimized for enhanced efficiency.

A further more common shortcoming of these prior art products is related to their safety of use. After the roasting is satisfactorily accomplished and when the food is still sizzling, the user can either take the risk of potential oil burn by taking it out immediately or wait for some time for the food to cool down a little bit. It is a common sense that when roasted foods stay in an enclosed space for some time, the internal moisture within the food will permeate out, thereby, causing the crispy food surface to lose its characteristics. Therefore, the latter is seldom an ideal option. In addition, there is residual cooking fume residing inside the roasting chamber, which may pollute the home environment if discharged directly into the room.

A still further more common shortcoming of these prior art products is concerned with their range of utility. They are generally designed for one specific application, namely, roasting. Consumers have to buy various apparatuses for different uses.

Therefore, it remains desirable to provide roasting apparatuses that can be used to prepare tasteful roasted foods and at the same time can be used for many other applications such as frying, baking, and fruit/vegetable drying, that favor homogeneous heating of foods and consume less energy, that are automatic to minimize the human involvement or chore during the roasting process, that are simple and safe to use, that are easy to clean after use, that are inexpensive to manufacture, and also that are environment, people, and home friendly.

### SUMMARY OF INVENTION

Accordingly, the present invention is an automatic roasting apparatus. This apparatus comprises a container having a open top and closed bottom and divided into an upper portion and a lower portion for ease of cleaning after use, a lid for covering on top of the container, a rotating device removably installed inside the container for holding foods, a heating device installed inside the container for heating foods, a motor operationally coupled with the rotating device through a transmission assembly for rotating the rotating device, a blowing device for forcing fresh air into the container to facilitate the evaporation and removal of moisture content residing in the surfaces of food pieces and to cool the food down fast to a predetermined temperature after the food is satisfactorily roasted, a centralized venting device for filtering and deodorizing cooking fumes, and an air circulating device for facilitating the air flow inside the container for a uniform heating. A control module is provided for controlling various functions of the roasting apparatus.

In another embodiment, this automatic roasting apparatus comprises a housing having a side opening and divided into an upper portion and a lower portion, a door for lockably closing up the opening, a rotating device removably installed inside the housing for holding foods, a heating device installed inside the housing for heating foods, a motor operationally coupled with the rotating device through a transmission assembly for rotating the rotating device, a blowing device for forcing fresh air into the housing to facilitate the evaporation and removal of moisture content residing in the surfaces of food pieces and to cool the food down fast after the food is roasted, a centralized venting device for filtering and deodorizing cooking fumes, and an air circulating device facilitating the air flow inside the housing for a uniform heating.

A method for roasting foods comprises steps of: providing a roasting apparatus having a roasting chamber, heating means installed inside the roasting chamber for heating foods, a centralized venting device for exhausting cooking fumes, and a blowing device for forcing fresh air into the roasting chamber; roasting foods until the foods are satisfactorily roasted; and forcing fresh air into the roasting chamber for cooling down the foods to a predetermined temperature and for purging the residual cooking fume residing inside the roasting chamber out of the roasting chamber through the centralized venting device; and whereby the foods are safe for handling; the important characteristics the foods are better preserved; and the residual cooking fumes are treated for home environment protection.

Accordingly, the followings are some of the objects, features, and advantages of the present invention:

It is an object of the present invention to provide a roasting apparatus for use to prepare tasteful roasted foods and at the same time to provide a roasting apparatus that can be used for many other applications, such as frying, baking, fruit/vegetable drying, etc.

It is another object of the present invention to provide a roasting apparatus that is environment, people, and home friendly.

It is a further more object of the present invention to provide a roasting apparatus that is simple and safe to use and easy to clean after use.

It is a still further more object of the present invention to provide a roasting apparatus that minimizes the interior space for maximum energy efficiency.

It is a still further more object of the present invention to provide a roasting apparatus that is automatic to minimize the human involvement or chore during the roasting process.

It is a still further more object of the present invention to provide a roasting apparatus that is of durable and reliable constructions, easily and efficiently manufactured and marketed, and at the same time economically available to the general public.

It is a feature of the present invention that this roasting apparatus has a centralized venting device for removing the oil vapor content in the grease-laden air generated during the roasting process before the air is exhausted into the room.

It is another feature of the present invention that this roasting apparatus has a blowing device to force fresh air into the roasting chamber for facilitating moisture removal during roasting, for reducing the food temperature for safety of food handling after the roasting is accomplished, and for preserving the important characteristics of the roasted food, such as food texture.

It is a further more feature of the present invention that this roasting apparatus has a two-piece container with all the electrical components installed on the upper portion. The upper portion removably rests on the lower portion and can be easily taking off. This two-piece container design greatly facilitates cleaning after use.

It is a still further more feature of the present invention that this roasting apparatus has a container having a semi-cylindrical bottom generally following the profile of the rotary drum, thereby minimizing the interior space for saving heating energy.

It is a still further more feature of the present invention that this roasting apparatus has a rotary drum installed inside a container for holding foods. A motor is provided to rotate this rotary drum. When the drum rotates, the food pieces therein are automatically separated and stirred for a homogeneous heating.

It is a still further more feature of the present invention that this roasting apparatus processes foods in a programmed automatic manner; therefore, minimal human involvement or chore is rendered.

It is an advantage of the present invention that this roasting apparatus is environment, people, and home friendly.

It is another advantage of the present invention that this roasting apparatus has a wide range of applications, such as roasting, frying, baking, fruit/vegetable drying, etc.

It is a further more advantage of the present invention that this roasting apparatus is virtually hand-free for roasting foods.

It is a still further more advantage of the present invention that this roasting apparatus is easy and safe to operate, cheap to manufacture, and provides large value to businesses and general public.

Further more features and advantages of the present invention will be readily appreciated, as the same becomes better understood after reading the subsequent description when considered in connection with the accompanying drawings.

### BRIEF DESCRIPTION OF DRAWINGS

FIG. 1 illustrates a cross-sectional view of roasting apparatus 100.

FIG. 2 illustrates a cross-sectional view of roasting apparatus 100, viewing toward drum shaft guide 112 of FIG. 1.

FIG. 3 illustrates a cross-sectional view of roasting apparatus 100, viewing toward drum shaft guide 114 of FIG. 1.

FIG. 4 illustrates a perspective view of roasting apparatus 100, indicating additional details revealed by lifting-up of lid 104.

FIG. 5 illustrates a perspective view of an enbodiment of rotating device 105, a perforated rotary drum 106.

FIG. 6 illustrates a cross-sectional view of drum 106.

FIG. 7 illustrates a perspective view of drum 106 with an alternative helical design of paddle blades 140.

FIG. 8 illustrates a perspective view of another embodiment of rotating device 105, a perforated rotary basket 142.

FIG. 9 illustrates a plan view of a further more embodiment of rotating device 105, a rotary frame 152.

FIG. 10 illustrates an exploded cross-sectional view of drive motor 108 and transmission assembly 110 of FIG. 1.

FIG. 11 illustrates an exploded cross-sectional view of seal assembly 182 of FIG. 10.

FIG. 12 illustrates an exploded cross-sectional view of venting device 200 of FIG. 1.

FIG. 13 illustrates an exploded cross-sectional view of blowing device 202 of FIG. 3.

FIG. 14 illustrates an exploded cross-sectional view of one-way valve 218 of FIG. 13.

FIG. 15 illustrates an exploded cross-sectional view of air circulating device 204 of FIG. 3.

FIG. 16 illustrates a blocked diagram of control circuit 190 for roasting apparatus 100.

FIG. 17 illustrates a perspective view of drum handle 199 in handling drum 106.

FIG. 18 illustrates a perspective view of roasting apparatus 300, another embodiment of the present invention.

FIG. 19 illustrates a cross-sectional view of roasting apparatus 300, taken along line A-A of FIG. 18.

FIG. 20 illustrates a cross-sectional view of roasting apparatus 300, taken along line B-B of FIG. 18.

FIG. 21 illustrates a perspective view of a further more embodiment of the present invention, a roasting apparatus 400.

### DETAILED DESCRIPTION

Although this invention is described as a roasting apparatus for the purpose of description and illustration, those skilled in the art will appreciate that it can, alternatively, be described as a frying apparatus, a baking apparatus, or a fruit/vegetable drying apparatus. Some key elements can, also, be readily applicable with microwave ovens.

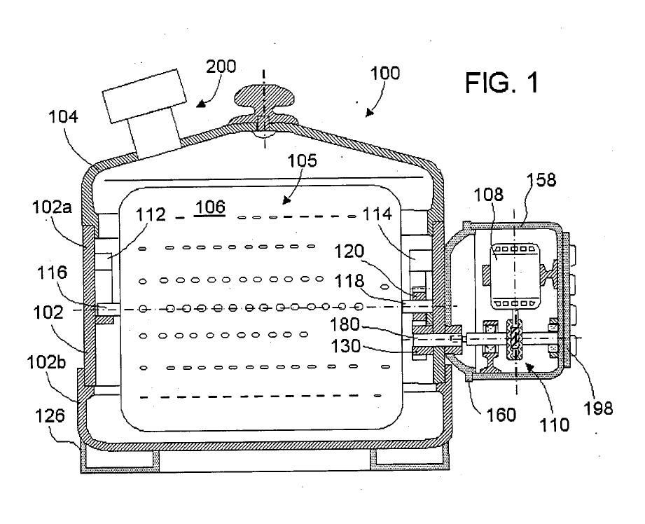

Reference is made to FIGS. 1 through 4, which illustrate an embodiment of the present invention, a roasting apparatus 100. Roasting apparatus 100 comprises a container 102, a lid 104, a rotating device 105, a drive motor 108, a transmission assembly 110, a centralized venting device 200, a blowing device 202, and an air-circulating device 204. For the purpose of illustration and description, rotating device 105 is embodied as a perforated rotary drum 106. Those skilled in the art will appreciate that this should not be construed as limiting the scope of this invention. Other mechanisms are covered by this invention and will be discussed later on.

As shown in FIG. 1, which illustrates a cross-sectional view of roasting apparatus 100. Container 102, having an open top, is divided into an upper portion 102a and a lower portion 102b. Lower portion 102b sealingly receives and supports upper portion 102a, which can be easily taking off for cleaning after use. Container 102 is, preferably, coated with a non-stick material. Lid 104 is provided for sealingly covering on top of container 102 for closing up the open top. Lid 104 is, preferably, made of a transparent material or a metal material but has an observation window (not shown), made of a transparent material, for observing the roasting process by the user. Container 102 and lid 104, together, form an enclosed roasting chamber.

Drum shaft guides 112 and 114 are firmly mounted inside container 102, on the sidewalls of upper portion 102a, on opposite sides, respectively, for removably installing drum 106 thereon.

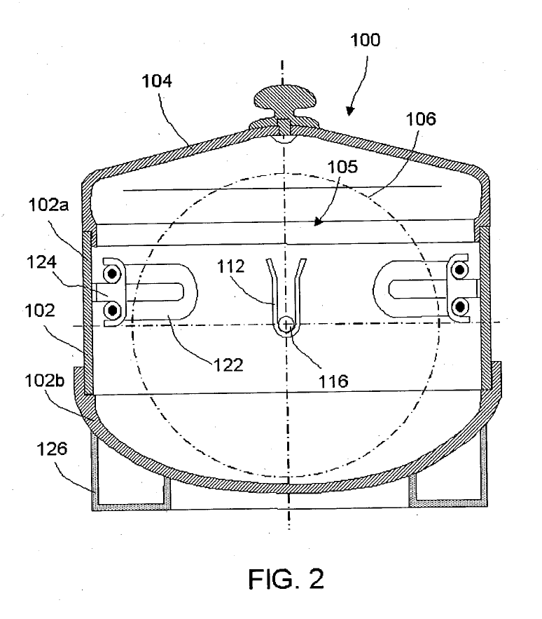

FIG. 2 illustrates a cross-sectional view of roasting apparatus 100, viewing toward guide 112 of FIG. 1. Guide 112 is for guiding and supporting a drum shaft 116, which is installed on one side of drum 106. The upper portion of guide 112 opens wider for conveniently receiving shaft 116. Shaft 116 rests on the lower portion of guide 112, which forms a semi-cylindrical bottom. Shaft 116 is co-axial to the semi-cylindrical bottom of guide 112.

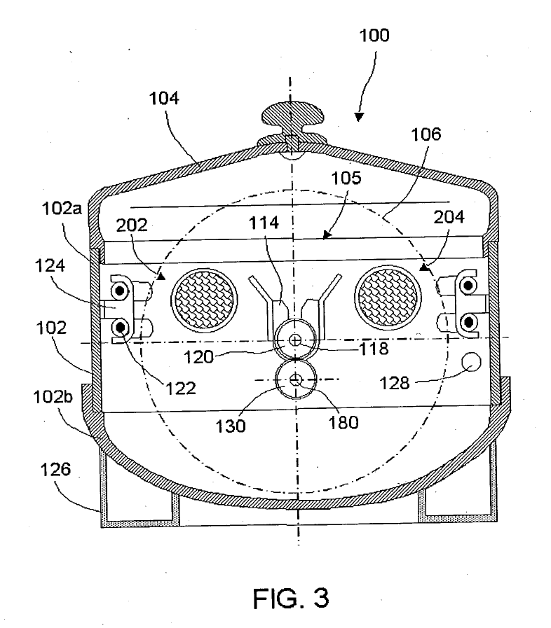

FIG. 3 illustrates a cross-sectional view of roasting apparatus 100, viewing toward guide 114 of FIG. 1. Guide 114 is for guiding and supporting another drum shaft 118, which is installed on the other side of drum 106. The upper portion of guide 114 opens wider for conveniently receiving a drum gear 120, which is installed on shaft 118, and shaft 118. Shaft 118 rests on the lower portion of guide 114, which forms a semi-cylindrical bottom. Shaft 118 is co-axial to the semi-cylindrical bottom of guide 114.

A heating element 122 is provided for heating the roasting chamber of roasting apparatus 100, as shown in FIG. 2 and FIG. 3. Heating element 122 is installed on the sides of container 102, on upper portion 102a, via a plurality of brackets, generally designated as 124. When heating element 122 heats up upon connection with an electricity source, the roasting chamber will also heat up.

Heating element 122 can be electrical resistance type heaters or many other types, such as high-intensity infrared lamps, as known to those skilled in the art and suggested by this invention disclosure.

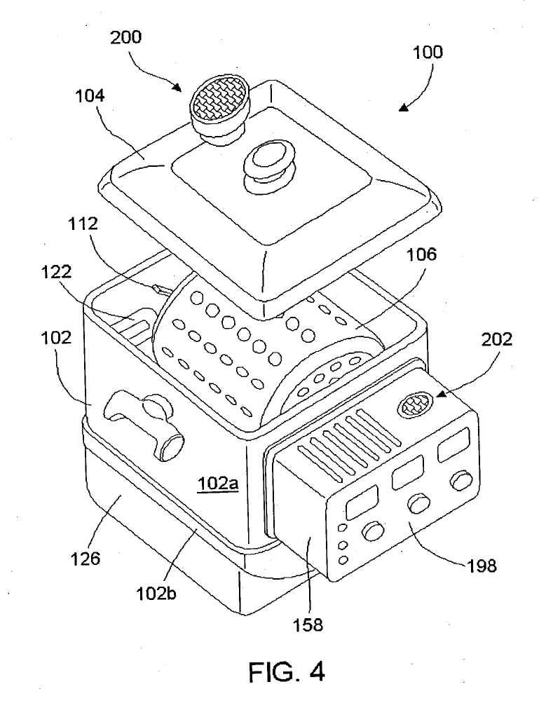

FIG. 4 illustrates a perspective view of roasting apparatus 100, indicating additional details revealed by lifting-up of lid 104. Upper portion 102a of container 102 generally forms the shape of a box, square or rectangular. Lower portion 102b of container 102 generally forms a semi-cylindrical bottom. The bottom of container 102 generally follows the profile of drum 106 with a predetermined clearance. Reference is made to FIG. 2 and FIG. 3 for a better view of the relative position of drum 106 to container 102. Basically, the smaller the clearance between drum 106 and container 102, the more compact roasting apparatus 100 is.

Many other shapes of container 102 are readily applicable with this application, also, such as the general shape of a conventional frying pot, as known to those skilled in the art and suggested by this invention disclosure.

An adapting member 126 is installed on the bottom of container 102 for providing a bottom support for roasting apparatus 100, such that roasting apparatus 100 can stand on a flat surface.

A temperature sensor 128, as shown in FIG. 3, is provided for measuring the temperature of the interior chamber, as an input variable to be controlled. Sensor 128 is installed on upper portion 102a of container 102. When the temperature of the interior chamber is above the user's desired one, the electrical power to heating element 122 will be shut down to better meet the user's desired roasting requirement and to save energy.

Reference is, again, made to FIG. 1. Drum 106, an embodiment of rotating device 105, made from perforated metal sheets, is provided for holding and roasting foods and is removably installed inside container 102 about a horizontal axis defined by guides 112 and 114. The perforations thereon are smaller than the food pieces to be roasted. Drum 106 is, preferably, coated with a non-stick material.

Shafts 116 and 118 are installed on the centers of two flat sides of drum 106, respectively, for operationally supporting drum 106. Both shafts 116 and 118 are co-axial to drum 106. Shaft 116 is guided and supported by guide 112. Shaft 118 is guided and supported by guide 114. Drum gear 120 is installed on shaft 118 and operationally rests on a drive gear 130, which is operationally driven by motor 108, as shown in FIG. 1. The engagement between gears 120 and 130 is assured by the gravity of drum 106 and the food therein.

The engagement of gears 120 and 130 can take some other forms, such as, instead of a pair of gearing wheels, the power transferring can, alternatively, be achieved by means of a pair of high-friction wheels.

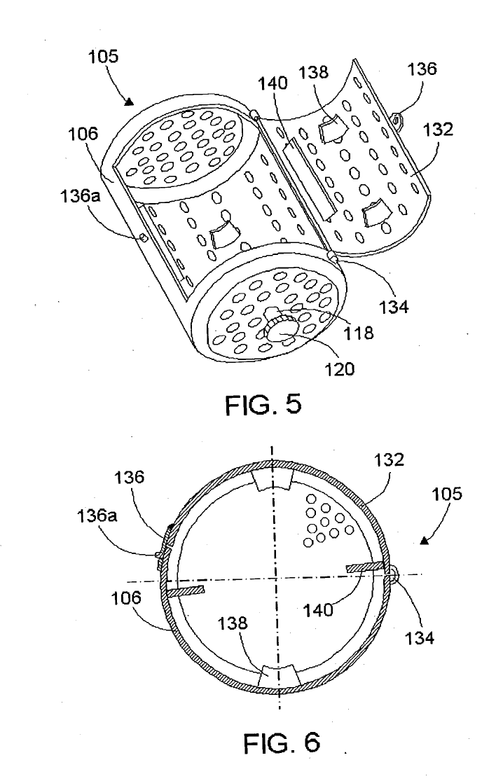

Reference is, now, made to FIG. 5 and FIG. 6. FIG. 5 illustrates a perspective view of drum 106 and FIG. 6 illustrates a cross-sectional view of drum 106. An opening is provided on drum 106 for loading raw foods and unloading finished foods. A door 132 is installed on the main body of drum 106 through a pair of hinges, generally designated as 134. Hinges 134 allow door 132 to be pivotally opened and closed on the main body of drum 106. The sizes of the opening and door 132 are substantially half of the cylindrical sidewall of drum 106 for the convenience of loading raw foods and unloading finished foods. Door 132 can be locked in its closed position in any suitable manner, such as by a clasp 136 mounted on door 132 and a projection 136a mounted on the main body of drum 106 for lockably receiving clasp 136.

An observation window (not shown), made of a transparent material, can be provided on drum 106 for facilitating the observation of roasting processes by the user.

The speed, at which drum 106 is rotated, is important. For too low speeds, the food pieces cannot be agitated enough to achieve the desired effect of homogeneous heating and the evaporation of food moisture. If the speed is too high, the food pieces are agitated too much, such that the crispy surfaces of food pieces are damaged. Preferably, drum 106 is rotated at a speed of about 0.5 to 10 rpm during the roasting process. Particularly, good results have been achieved when drum 106 is rotated at 6 rpm.

In reality, different stages of a roasting process require different rotation speeds. For example, at the very beginning, the speed is, preferably, low for the food pieces to form initial crispy surfaces. After the initial crispy surfaces are formed and large lumped-together food pieces are separated, the speed is, preferably, to increase steadily to a predetermined ideal speed. The control of the speed can be achieved in a programmed automatic manner.

A plurality of separating blades, generally designated as 138, is provided inside drum 106 and installed on the cylindrical sidewall, for separating the initially lumped-together food pieces, such as raw meat pieces mixed with starch and seasoning ingredients, etc. Blades 138 are generally perpendicular to the central axis of drum 106 and parallel to the two flat sides of drum 106. This separating operation facilitates the heat transferring for a homogeneous heating of the food and facilitates the evaporation of moisture residing in the surfaces of food pieces.

A plurality of paddle blades, generally designated as 140, is provided inside drum 106 and installed on the cylindrical sidewall, for preventing the food from sliding therealong as drum 106 rotates. Blades 140 are generally parallel to the central axis and extend longitudinally on the cylindrical sidewall of drum 106. In operation, blades 140 take the food rotating with them at the bottom and then tumble the food down when the food pieces reach a certain height. This agitating operation facilitates the heat transferring for a homogeneous heating of the food and facilitates the evaporation of moisture residing in the surfaces of food pieces.

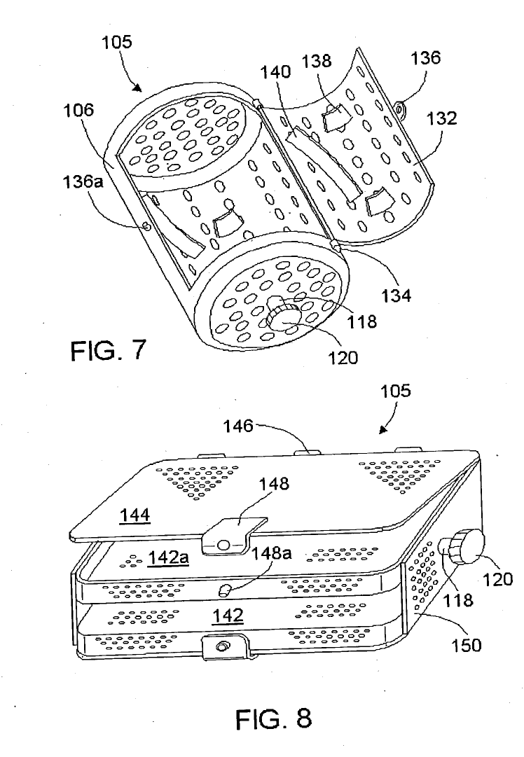

Blades 140 can, alternatively, take some other shapes, such as a helical design, as shown in FIG. 7, for better agitating the food during the roasting process while drum 106 rotates.

Equivalent constructions of blades 140 can, also, be made from protrusions inside drum 106 formed on the cylindrical sidewall. Many other configurations, known to those skilled in the art and suggested by this invention disclosure, are readily applicable with this application.

A predetermined mount of oil can be disposed in lower portion 102b of container 102 for providing some oil for the food to be roasted, such that the roasted food is having a similar texture of fried foods. At an operation position, only the lower portion of drum 106 is immersed in the oil. The oil level can be adjusted for various roasting and frying requirements or methods.

Frying foods is another application of roasting apparatus 100, in addition to roasting foods. In frying foods, drum 106 is partially immersed in the oil. When drum 106 rotates, the food pieces therein are tumbled into the oil periodically and automatically separated and stirred for a homogeneous heating. Unlike traditional frying, the food pieces then are fried mostly while they are out of the oil and the heat transferring is mostly achieved through radiation and heated air. This type of frying method greatly favors low fat frying.

Drum 106 is especially good for re-heating semi-cooked frozen foods, such as French fries, chicken nuggets, etc., and baking dry foods, like various nuts.

Drum 106 is readily applicable for drying foods, such as fruit and vegetable pieces. In this case, the temperature should be set much lower than those for roasting and frying foods.

Drum 106 is ideal for preparing food pieces that are much smaller compared with the dimension of drum 106. For larger food pieces, such as steaks, chicken quarters, whole chickens, hamburger meat pads, etc., other types of rotating device 105 are provided.

FIG. 8 illustrates another embodiment of rotating device 105, a rotary basket 142, made from perforated metal sheets or metal wire meshes. Basket 142 has two flat box-like baskets, generally designated as 142a, each having an open flat side. Baskets 142a are equipped with doors, 144, pivotally installed on the main body of baskets 142a via a plurality of hinges, generally designated as 146, for closing up the openings thereof. Two clasps 148, installed on doors 144, are provided for releasably locking doors 144 onto the main body of baskets 142a. Two projections 148a are installed on the main body thereof for lockably receiving clasps 148. Baskets 142a are installed in between two rigid sideboards 150 and disposed back-to-back with a predetermined clearance in between for facilitating airflow and homogeneous heating. Shafts 116 and 118 are installed on the centers of sideboards 150, respectively, for operationally supporting basket 142 on guides 112 and 114, as shown in FIGS. 1 through 3 for drum 106.

Basket 142 is ideal for roasting foods, like steaks, hamburger meat pads, etc., or baking foods, like oriental style flat breads, and so on. Basket 142 can be alternatively designed as a single box-like basket such that it can be used for baking buns and some other larger foods.

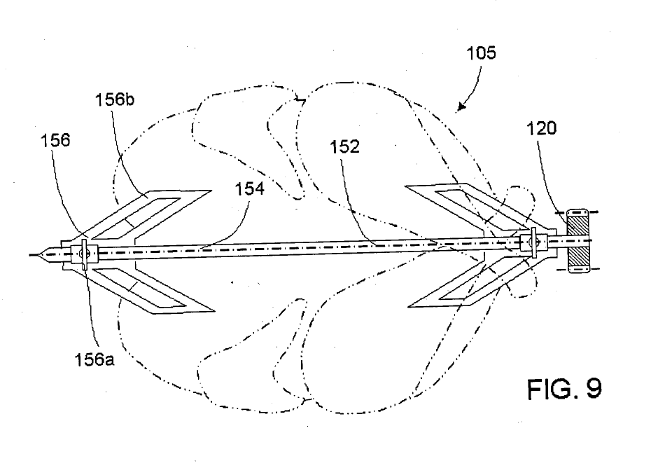

FIG. 9 illustrates a further more embodiment of rotating device 105, a rotary frame 152, which is provided for roasting much larger food pieces. Frame 152 includes a square skewer 154 and two fixtures 156. Square skewer 154 has one sharp engaging end. Each of fixtures 156 has a bolt 156a and two extending forks 156b from respective ends thereof. Skewer 154 is slipping through a large piece of meat, such as whole chicken, and is holding it firmly thereon with two forks 156b of fixtures 156 also slipping into the meat piece. Skewer 154 is secured by bolts 156a to fixtures 156, respectively. The sharp engaging end of square skewer 154 is guided and supported by guide 112, whereas the other end is engaged with gear 120, which is guided and supported by guide 114, as shown in FIGS. 1 through 3 for drum 106.

Although three embodiments of rotating device 105 have been discussed above, many other designs can be readily applicable, as known to those skilled in the art and suggested by this invention disclosure.

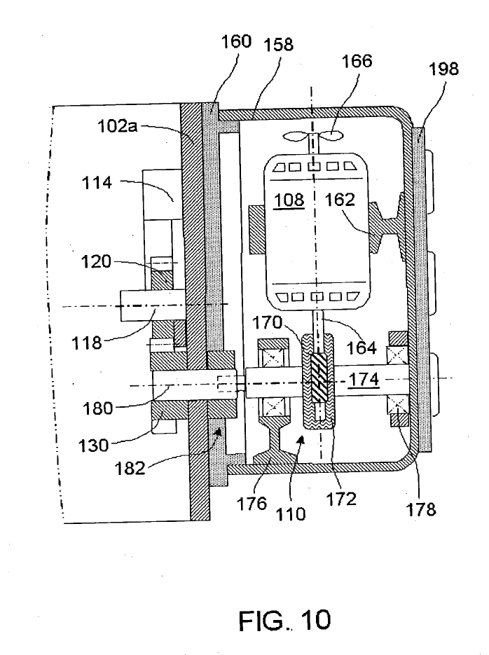

FIG. 10 illustrates an exploded cross-sectional view of motor 108 and transmission assembly 110 of FIG. 1.

A motor housing 158 is removably installed on the sidewall of upper portion 102a of container 102 through an adapting bracket 160. Bracket 160 is installed on the sidewall of container 102a for lockably receiving motor housing 158. Bracket 160 is, preferably, made of a heat resistant material.

Motor 108 is installed inside motor housing 158 through a bracket 162. The first end of a motor shaft 164 extends to transmission assembly 110. A fan 166 is fixed to the second end of motor shaft 164 for circulating the air inside motor housing 158 to maintain the temperature, therein, low. Motor 108 is operationally connected to a DC adapter 168, as shown in FIG. 15 and discussed later on.

A worm rod 170 is installed on the first end of motor shaft 164. A worm wheel 172, which is installed on and supported by a main shaft 174, is engaged with worm rod 170 for transferring power from motor 108 to main shaft 174.

There are many reasons why a worm-gearing device is used therein. Worm gearing, properly designed and produced, provides a good trouble-free drive for smooth operation and permits a wide selection of ratios. The primary benefit is that a worm-gearing device requires a small space.

The selection of materials is critical. SAE 65 bronze with about 1% nickel is good for worm wheel 172. Worm rod 170 should be hardened steel with the threads ground after hardening.

Main shaft 174 is installed onto motor housing 158 through a bracket 176 and a plurality of bearing elements, generally designated as 178. The drive end of main shaft 174 forms a square head or gear head leading to a drive shaft 180.

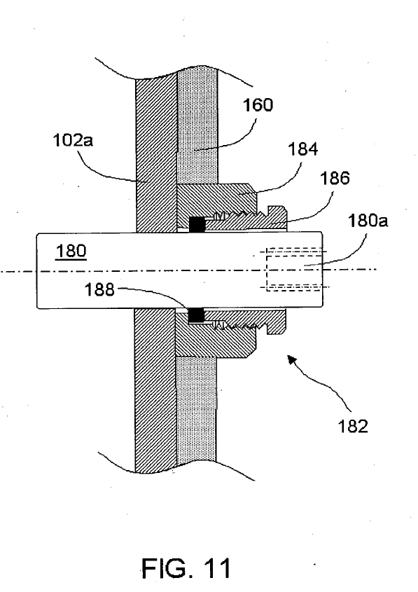

The first end of drive shaft 180 has an inner gear 180a, as more clearly shown in FIG. 11, for removably receiving the drive end of main shaft 174, such that this end loosely or removably engages with the square head of main shaft 174. This kind of coupling dramatically reduces the co-axial requirement on main shaft 174 and drive shaft 180 and facilitates the assembly process for manufacturing. The second end of drive shaft 180 extends through the sidewall of container 102a.

Drive gear 130 is installed inside container 102a on the second end of drive shaft 180. Drum gear 120, engaged with drive gear 130, rests on drive gear 130. The engagement is secured or facilitated by the gravity of drum 106 and the food therein. This wheeled drive design eliminates the possibility of overloading of motor 108 and transmission 110, due to some accidental events such that drum 106 is mechanically stopped inside container 102.

A seal assembly 182 is provided for sealing between shaft 180 and container 102a. FIG. 11 illustrates an exploded cross-sectional view of seal assembly 182. Seal assembly 182 comprises a seal flange 184, a gland nut 186, and a compression packing 188.

Flange 184 is co-axial to drive shaft 180. The first end of flange 184 is sealingly installed on the outside surface of the sidewall of container 102a. Gland nut 186 is engaged with the second end of flange 184 by means of screw. Packing 188 creates a seal by being squeezed between the throat of the stuffing box formed by flange 184 and gland nut 186. The squeeze force pushes the material against the throat of the box and the rotating shaft 180. When leakage occurs, the gland nut 186 is tightened further. This is a typical application of compression packings for low speed rotating shafts, such as shaft 180.

Materials are extremely important when selecting the proper packing for an application. Metallic packings are used in high-temperature applications. Shafts for copper and aluminum packings must be hardened to 500 Brinell hardness number (Bhn). Copper and aluminum packings can handle 538Â°C. (1000Â°F.) application temperature.

Seal assembly 182 can, alternatively, take many other forms, such as bushing and labyrinth seals, or combinations of multiple forms for ideal performance, as known to those skilled in the art and suggested by this invention disclosure.

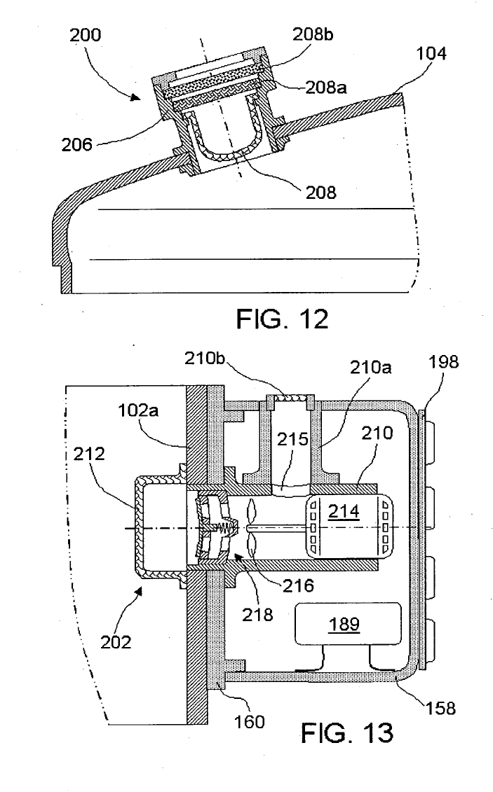

Reference is, now, made to FIG. 12 and FIG. 13, which illustrate an embodiment of a forced venting system, which includes a centralized venting device 200 of FIG. 1 and a blowing device 202 of FIG. 3.

Venting device 200 includes a venting conduit 206 and a venting filter 208. The first end of venting conduit 206 is mounted on lid 104 There is an opening on lid 104 inline with venting conduit 206 for allowing cooking fumes to be forced out therethrough. Venting conduit 206 also serves as a bracket for holding venting filter 208. Venting filter 208 is removably engaged with the second end of venting conduit 206. Venting filter 208 further includes a disposable paper filter 208a and/or a disposable activated charcoal filter 208b, together, as an integrated filter.

Venting filter 208 is provided to trap the grease impurities in the grease-laden air forced out from roasting apparatus 100. Venting filter 208 is, preferably, made of one or multiple layers of metal meshes, such as aluminum ones. Metal meshes have different sizes of meshes and overlap each other. When cooking fumes pass therethrough, the oil particles will be trapped thereon. Filters 208a and 208b are provided for further removing the remaining oil vapor and chemical contents in the cooking fumes and for removing the cooking fume odors before the air is exhausted into the room.

Blowing device 202 includes an in-take conduit 210, an in-take filter 212, a blowing motor 214, a fan 216, and a one-way valve 218.

The first end of in-take conduit 210 is mounted on the sidewall of container 102a. There is an opening on the sidewall of container 102a inline with in-take conduit 210 for allowing fresh air to be forced into roasting apparatus 100. There is an aperture 215 on in-take conduit 210. Aperture 215 functions as an air inlet. An inlet conduit 210a extends from aperture 215 to the outside space, such that fresh air outside atmosphere can be readily drawn into roasting apparatus 100. A filter 210b, made from metal meshes is provided for preventing some large particles being drawn therein. In-take conduit 210 also serves as a bracket for holding motor 214 in position. In-take filter 212 is removably installed on the inner sidewall of container 102a Motor 214 is removably coupled with the second end of in-take conduit 210. Fan 216 is connected to motor 214 on the shaft and inserted inside in-take conduit 210. Motor 214 is operationally connected to adapter 168, which is shown in FIG. 15.

In-take filter 212primarily functions as a shield for fan 216 and motor 214 against potential splattering of grease and food particles and is typically made of one or multiple layers of meshes, preferably metal ones, such as aluminum meshes.

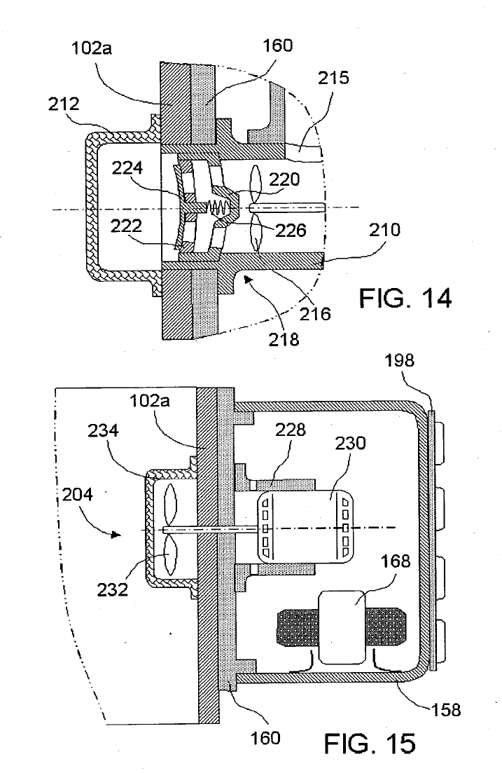

As shown in FIG. 14, which illustrates an exploded cross-sectional view of one-way valve 218 of FIG. 13. Valve 218 includes a valve housing 220, a valve body 222, a covering piece 224, and a spring 226. Valve housing 220 is engaged with the first end of in-take conduit 210. There are apertures on valve housing 220 for allowing air to pass therethrough. Valve body 222 is engaged with the open end of valve housing 220. There are apertures on valve body 222 for allowing air to pass therethrough. Covering piece 224 covers on valve body 222 for closing and opening valve 218. There is a central protrusion on covering piece 224 The central protrusion is slidably inserted into a central aperture on valve body 222, such that the protrusion can slide along the central aperture for a predetermined distance. Spring 226 is attached between the protruding end of the protrusion and valve housing 220, such that spring 226 is biased in slight tension, thereby, pulling covering piece 224 toward/against valve body 222 for closing up valve 218.

When blowing device 202 is in working condition, the air pressure generated by fan 216 forces covering piece 224 to slide away from valve body 222, such that valve 218 is in an opening position for allowing air to pass therethrough. Valve 218 is provided for preventing the heated air and cooking fumes inside roasting apparatus 100 from escaping through blowing device 202 while blowing device 202 is temporarily not in working condition.

Those skilled in the art will appreciate in view of this invention disclosure that many other suitable valve designs are readily applicable for this application of the present invention.

Venting device 200 and blowing device 202 can be alternatively installed on roasting apparatus 100 at many other positions. For example, venting device 200 can be alternatively installed on container 102a and blowing device 202 can be alternatively mounted on lid 104. These variations are covered by this invention disclosure.

Venting device 200 is provided for cooking fume treatment. Compared with prior art products, which allow cooking fumes to escape freely, this centralized venting system design vents cooking fumes in a controlled manner, such that heating energy is better preserved for a more efficient roasting apparatus.

Blowing device 202 is provided for forcing moisture content out of roasting apparatus 100, especially at the early stage of a roasting process, such that roasting apparatus 100 can roast foods of great taste, great texture, and great looking. This also favors less cooking time and, as a result, less energy consumption. However, there is some energy loss associated with using blowing device 202. Therefore, the use of blowing device 202 should be in a controlled manner, for example, intermittently for an ideal effect. The length of working and pausing time periods is a good variable to control.

Immediately after the roasting is satisfactorily accomplished, the food is still sizzling hot and there is still residual cooking fume residing inside roasting apparatus 100. Blowing device 202 is used to bring in fresh air to cool the food down to a predetermined temperature and at the same time to purge the residual cooking fumes out through venting device 200. This process greatly favors safety of food handling, home environment protection, and foods of great texture and looking.

Venting device 200 and blowing device 202 are necessary elements for the application of drying foods, in which fresh air is forced in and moisture is vented out. In this case, venting filter 208 is not necessary and is, preferably, removed.

Reference is made to FIG. 15, which illustrates a cross-sectional view of air circulating device 204 of FIG. 3. Circulating device 204 includes a mounting flange 228, a motor 230, a fan 232, and a metal mesh filter 234.

Flange 228 is installed on bracket 160. Motor 230 is engaged with the free end of flange 228. Fan 232 is fixedly attached to a motor shaft, which extends from motor 230 through the sidewall of container 102a. Filter 234 is installed inside container 102a covering fan 232. Filter 234 is provided for protecting fan 232 against grease splattering.

Circulating device 204 is provided for circulating the air inside roasting apparatus 100 for favoring homogeneous heating. For a compact roasting apparatus design, such as roasting apparatus 100 of the present invention, better air circulation inside the roasting chamber can greatly reduce the risk of localized scorching of the food. After the food is roasted, circulating device 204 works together with blowing device 202 to cool the food down to a predetermined temperature for safety of food handling and preservation of food texture. Circulating device 204 also works together with blowing device 202 in the application of drying fruit and vegetable pieces in facilitating evaporation of moisture content.

As shown in FIG. 15, DC adapter 168 is provided inside motor housing 158for providing electricity power to elements, like indicators, beepers, LCD, etc., and to motors 108, 214, and 230, as well. Also included therein is a control module 189, as shown in FIG. 13, for controlling roasting apparatus 100, such as roasting chamber temperature, motor speeds and time for rotating drum 106, and the speeds and time at which blowing motor 214 and circulating motor 230 are rotating.

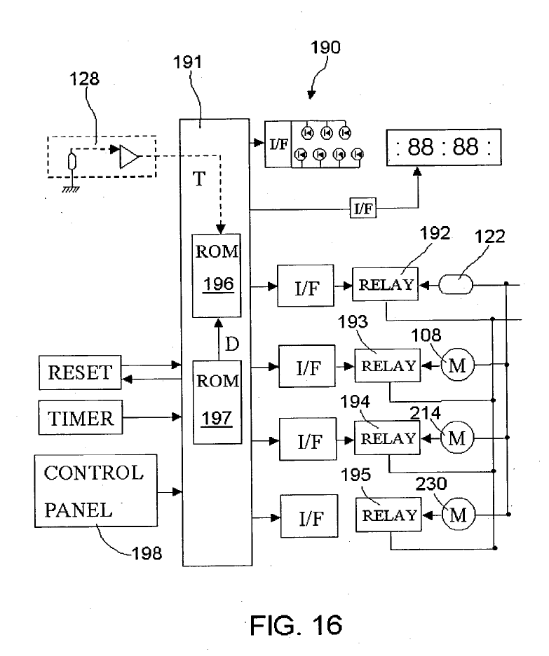

Control module 189, as shown in FIG. 13, is provided for controlling various parameters of roasting apparatus 100. Control module 189 includes a circuit 190, as the blocked construction diagram shown in FIG. 16. Circuit 190 comprises a microcomputer 191, which controls roasting apparatus 100, a relay 192, which activates heating element 122, a relay 193, which activates motor 108, a relay 194, which activates motor 214, and a relay 195, which activates motor 230.

Microcomputer 191 is provided with ROM and RAM for data memory, and further provided with I/O ports A/D converters as interfaces. The aforementioned ROM's comprises a ROM 196 containing control programs related to the performance of all roasting processes and a ROM 197, which memorizes referenced data.

A control panel 198, removably attached on motor housing 158, is provided for supporting elements, like switches, indicators, adjusting knobs, beepers, LCD, and so on.

In operation, a user:

First, loads drum 106 with the food to be roasted. A predetermined amount of oil can be disposed in container 102 for frying foods.

Second, installs drum 106 inside container 102 and covers lid 104 on the top of container 102.

Third, selects a temperature, a time duration, a drum rotation speed, and a blowing motor speed, or a program for roasting foods, and then pushes on start button for activating the roasting process.

The whole roasting process is hand-free. The user does not have to be involved with the roasting process until the roasting is done. Roasting apparatus 100 will beep to remind the user when the roasting-process is done.

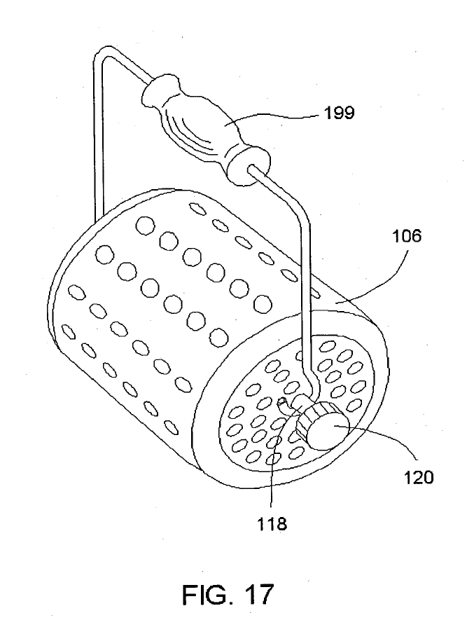

Then drum 106 can be taken out using a drum handle 199, as shown in FIG. 17. Drum handle 199 is an auxiliary part, which is used for installing drum 106, or other types of rotating device 105, in position and for taking drum 106 out when the roasting is accomplished. The roasted food is, now, ready for serving.

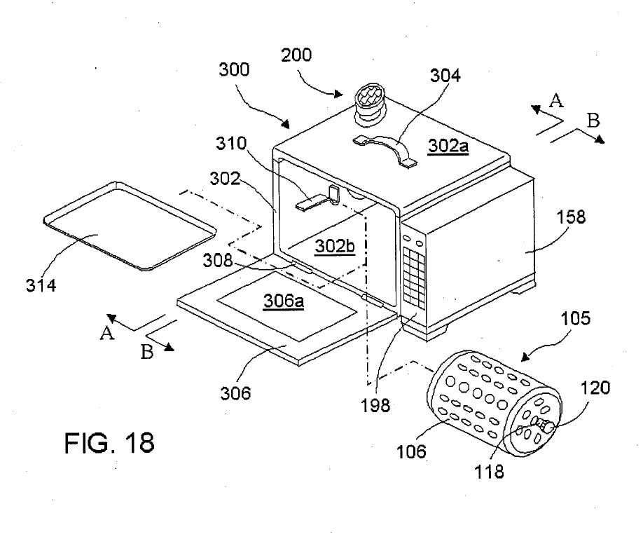

Reference is made to FIGS. 18 through 20, which illustrate another embodiment of the present invention, a roasting apparatus 300. Some components or devices of roasting apparatus 300 are similar to those roasting apparatus 100. Similarity is in the sense of both functionality and configuration. Therefore, similar components or devices are denoted with similar reference numbers for avoiding repetitive explanations. Reference is made to roasting apparatus 100 for detailed information about these similar components or devices.

As shown in FIG. 18, which illustrates a perspective view of roasting apparatus 300. Housing 302, having an open side, is divided into an upper portion 302a and a lower portion 302b. Lower portion 302b sealingly and removably receives and supports upper portion 302a. Upper portion 302a can be easily taking off for cleaning. Another advantage of this separation is that by taking off upper portion 302a, much larger food pieces can be loaded and unloaded therethrough with much less effort, compared with prior art products having just a side opening. A handle 304 is provided for handling upper portion 302a. A door 306, pivotally installed on the main body of housing 302, via a plurality of hinges 308, is provided for sealingly and lockably closing up the opening side. Door 306 is preferably provided with an observation window 306a, made of a transparent material, for observing the roasting process by the user. Housing 302 and door 306, together, form an enclosed roasting chamber.

Those skilled in the art will appreciate in view of this invention disclosure that door 306 could be pivotally installed on any one of the four sides of the opening.

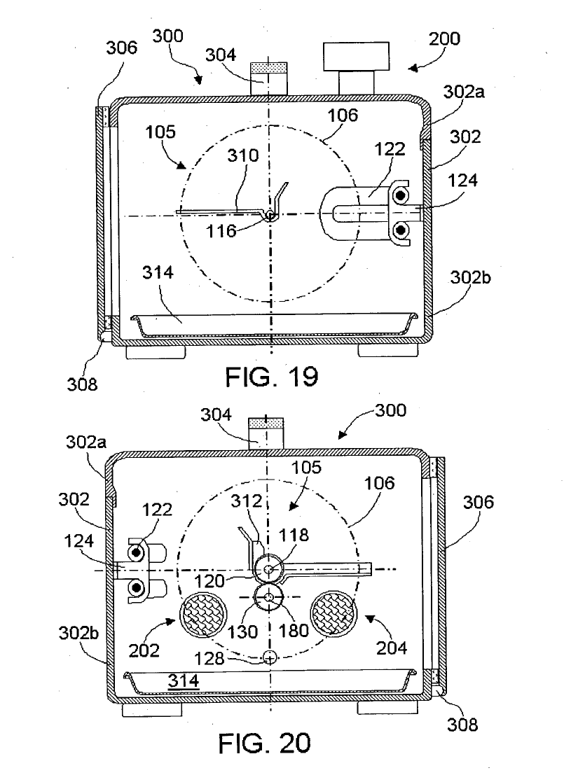

FIG. 19 illustrates a cross-sectional view of roasting apparatus 300, taken along line A-A of FIG. 18. Drum shaft guides 310 is firmly mounted inside housing 302, on the sidewall, for removably installing drum 106 thereon. Guide 310 is for guiding and supporting drum shaft 116, which is installed on one side of drum 106. One end of guide 310 extends toward door 306. The other end of guide 310 forms a semi-cylindrical bottom. Guide 310 is provided for conveniently receiving shaft 116. Shaft 116 rests on the semi-cylindrical bottom of guide 310.

FIG. 20 illustrates a cross-sectional view of roasting apparatus 300, taken along line B-B of FIG. 18. Guide 312 is for guiding and supporting another drum shaft 118, which is installed on the other side of drum 106. One end of guide 312 extends toward door 306. The other end of guide 312 forms a semi-cylindrical bottom. Guide 312 is provided for conveniently receiving drum gear 120, which is installed on shaft 118, and shaft 118. Shaft 118 rests on the semi-cylindrical bottom of guide 312.

A tray 314 is provided for collecting dripping down oil during roasting. Tray 314 rests on the interior floor of housing 302.

Other features are similar to those of roasting apparatus 100.

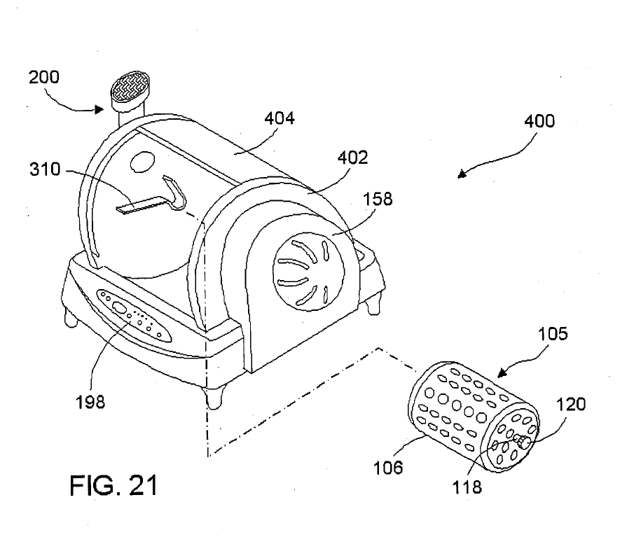

Reference is made to FIG. 21, which illustrates a further more embodiment of the present invention, a roasting apparatus 400. Some components or devices of roasting apparatus 400 are similar to those roasting apparatuses 100 and 300. Similarity is in the sense of both functionality and configuration. Therefore, similar components or devices are denoted with similar reference numbers for avoiding repetitive explanations. Reference is made to roasting apparatuses 100 and 300 for detailed information about these similar components or devices.

As shown in FIG. 21, housing 402 has a generally cylindrical configuration. There is a side opening for loading and unloading foods. A sliding door 404, as shown at an open position, is installed on the main body of housing 402 for sealingly closing up the opening. Venting device 200 is installed on one flat side and electrical components and devices are installed on the other flat side. Other features are similar to roasting apparatuses 100 and 300.

Accordingly, readers will see that this roasting apparatus of the present invention can be used to prepare tasteful roasted foods and at the same time can be used for many other applications, such as frying, baking, and fruit/vegetable drying. This roasting apparatus has a rotary drum, which tumbles the food inside the roasting chamber to achieve a homogeneous heating. During the time when the food pieces are lifted high, the moisture in food piece surfaces is facilitated to evaporate by a blowing device and an air-circulating device. The roasting process is fully automatic, thereby minimizing human involvement and chore. The grease-laden air generated during the roasting process is forced out through a venting device and filtered before being discharged into the room, thereby avoiding long-term hazards to the people and home environment. The two-piece container design, with all the electrical components installed on the upper portion, greatly facilitates the cleaning after use. Using the blowing device to cool the food down to a predetermined temperature after the roasting is done greatly favors safety of food handling and preservation of food texture.

The present invention has been described in an illustrative manner. It is to be understood that the terminology, which has been used, is intended to be in the nature of words of description rather than of limitation.

Although the invention has been described in its preferred forms and structures with a certain degree of particularity, these should not be construed as limiting the scope of the invention but as merely providing illustrations of some of the presently preferred embodiments of this invention.

For examples, although this invention has been described in a form of home roasting apparatuses, it can have potential business use, such as use in restaurants. Therefore, this invention can alternatively be described as food processing equipment. Although this invention has been described as a roasting apparatus for the purpose of description and illustration, those skilled in the art will appreciate that it can, alternatively, be described as a frying apparatus, a baking apparatus, or a fruit/vegetable drying apparatus. Some key elements can, also, be readily applicable with microwave ovens. Although the forced venting system of the present invention has been described in a form of blowing fresh air into the roasting apparatus, it is understood that rearrangement of the motor, fan, and filters, such that, instead of blowing fresh air into the roasting apparatus, the fan actually draws the moisture-laden and grease-laden air out of the roasting apparatus, is perfectly inline with the spirit of forced venting concept. Such rearrangement is, therefore, covered by the present invention.

Thus it is understood that the present invention disclosure of the preferred forms can be changed in the details of construction and in the combination and arrangement of parts without departing from the spirit and the scope of the invention as hereinafter claimed.

1. A roasting apparatus, said roasting apparatus comprising:
a roasting chamber for roasting foods;
heating means installed inside said roasting chamber for heating said foods; and
a venting device for exhausting cooking fumes.

2. A roasting apparatus as defined in claim 1, wherein said venting device includes filter means for cooking fume treatment.

3. A roasting apparatus as defined in claim 1, said roasting apparatus further including a blowing device for forcing fresh air into said roasting chamber, thereby facilitating moisture removal from inside said roasting chamber.

4. A roasting apparatus as defined in claim 3, wherein said blowing device includes a one-way valve for preventing heated air and cooking fumes from escaping therethrough while said blowing device is temporarily not in working condition.

5. A roasting apparatus as defined in claim 1, said roasting apparatus further including an air-circulating device for circulating the air inside said roasting chamber.

6. A roasting apparatus as defined in claim 3, said roasting apparatus further including an air-circulating device for circulating the air inside said roasting chamber.

7. A roasting apparatus as defined in claim 1, said roasting apparatus further including:
a rotating device removably installed inside said roasting chamber for holding said foods;
at least one shaft guide installed inside said roasting chamber for guiding and supporting said rotating device; and
a drive motor operationally connected to an electrical power supply for operationally rotating said rotating device.

8. A roasting apparatus as defined in claim 7, wherein said rotating device is a rotary drum having at least a paddle blade installed inside said rotary drum for preventing said foods from sliding along said rotary drum as said rotary drum rotates.

9. A roasting apparatus as defined in claim 3, said roasting apparatus further including:
a rotating device removably installed inside said roasting chamber for holding said foods;
at least one shaft guide installed inside said roasting chamber for guiding and supporting said rotating device; and
a drive motor operationally connected to an electrical power supply for operationally rotating said rotating device.

10. A roasting apparatus as defined in claim 9, said roasting apparatus further including control means for controlling various functions of said roasting apparatus, whereby roasting processes are accomplished in a programmed automatic manner for minimizing human involvement.

11. A roasting apparatus, said roasting apparatus comprising:
a container having an open top;
a lid for covering on top of said container for closing up said open top of said container; and
heating means installed inside said container for heating foods; and
wherein said container is divided into an upper portion and a lower portion; and said lower portion of said container removably receives and supports said upper portion of said container; and
whereby said roasting apparatus is convenient for cleaning after use.

12. A roasting apparatus as defined in claim 11, said roasting apparatus further including a venting device for exhausting cooking fumes.

13. A roasting apparatus as defined in claim 12, said roasting apparatus further including a blowing device for forcing fresh air into said roasting apparatus, thereby facilitating moisture removal from inside the roasting chamber of said roasting apparatus.

14. A roasting apparatus as defined in claim 11, said roasting apparatus further including:
a rotating device removably installed inside said container for holding said foods;
at least one shaft guide installed inside said container for guiding and supporting said rotating device; and
a drive motor operationally connected to an electrical power supply for operationally rotating said rotating device.

15. A roasting apparatus as defined in claim 14, wherein said rotating device is a rotary drum having at least a paddle blade installed inside said rotary drum for preventing said foods from sliding along said rotary drum as said rotary drum rotates.

16. A roasting apparatus as defined in claim 12, said roasting apparatus further including:
a rotating device removably installed inside said container for holding said foods;
at least one shaft guide installed inside said container for guiding and supporting said rotating device; and
a drive motor operationally connected to an electrical power supply for operationally rotating said rotating device.

17. A roasting apparatus as defined in claim 13, said roasting apparatus further including:
a rotating device removably installed inside said container for holding said foods;
at least one shaft guide installed inside said container for guiding and supporting said rotating device; and
a drive motor operationally connected to an electrical power supply for operationally rotating said rotating device.

18. A roasting apparatus as defined in claim 17, said roasting apparatus further including control means, for controlling various functions of said roasting apparatus, whereby roasting processes are accomplished in a programmed automatic manner for minimizing human involvement.

19. A roasting apparatus, said roasting apparatus comprising:
a container having an open top;
a lid for covering on top of said container for closing up said open top of said container;
heating means installed inside said container for heating foods;
a rotating device removably installed inside said container for holding said foods;
at least one shaft guide installed inside said container for guiding and supporting said rotating device; and
a drive motor operationally connected to an electrical power supply for operationally rotating said rotating device.

20. A roasting apparatus as defined in claim 19, wherein said rotating device is a rotary drum having at least a paddle blade installed inside said rotary drum for preventing said foods from sliding along said rotary drum as said rotary drum rotates.

21. A roasting apparatus, said roasting apparatus comprising:
a housing having an open side;
a door pivotally installed on said housing for closing up said open side; and
heating means installed inside said housing for heating foods; and
wherein said housing is divided into an upper portion and a lower portion; and said lower portion of said housing removably receives and supports said upper portion of said housing; and
whereby said roasting apparatus is convenient for food handling and easy for cleaning after use.

22. A roasting apparatus as defined in claim 21, said roasting apparatus further including:
a rotating device removably installed inside said housing for holding said foods; at least one shaft guide installed inside said housing for guiding and supporting said rotating device; and
a drive motor operationally connected to an electrical power supply for operationally rotating said rotating device.

23. A roasting apparatus as defined in claim 22, wherein said rotating device is a rotary drum having at least a paddle blade installed inside said rotary drum for preventing said foods from sliding along said rotary drum as said rotary drum rotates.

24. A method for roasting foods, said method comprising steps of:
providing a roasting apparatus, said roasting apparatus comprising a roasting chamber, heating means installed inside said roasting chamber for heating said foods, a venting device for exhausting cooking fumes, and a blowing device for forcing fresh air into said roasting chamber;
roasting said foods until said foods are satisfactorily roasted; and
forcing fresh air into said roasting chamber for cooling down said foods to a predetermined temperature and for purging the residual cooking fume residing inside said roasting chamber out of said roasting chamber through said venting device; and whereby said foods are safe for handling; and the important characteristics of said foods are better preserved.

25. A method for roasting foods as defined in claim 24, wherein said venting device of said roasting apparatus includes filter means for cooking fume treatment for better home environment protection.
